(19) United States
(12) Patent Application Publication
(10) Pub. No.: US 2026/0019997 A1
(43) Pub. Date: Jan. 15, 2026

(54) METHOD FOR TRANSMITTING PAGING MESSAGES, CORE NETWORK ELEMENT, AND NETWORK DEVICE

(71) Applicant: GUANGDONG OPPO MOBILE TELECOMMUNICATIONS CORP., LTD., Dongguan (CN)

(72) Inventors: Haitao LI, Dongguan (CN); Yi HU, Dongguan (CN)

(21) Appl. No.: 19/334,955

(22) Filed: Sep. 21, 2025

Related U.S. Application Data
(63) Continuation of application No. PCT/CN2023/085193, filed on Mar. 30, 2023.

(51) Int. Cl. H04W 68/02; H04W 60/04; H04W 64/00; H04W 84/06

(52) U.S. Cl. CPC H04W 68/02; H04W 60/04; H04W 64/00; H04W 84/06

(57) ABSTRACT

Provided is a method for transmitting paging messages. The method is performed by a core network element. The method includes: transmit a first paging message; wherein the first paging message is configured for a network device to determine a timing for transmitting a second paging message, and the first paging message carries at least one of: position-associated information of a paged terminal or time-associated information.

### CROSS-REFERENCE TO RELATED APPLICATION

This application is a continuation of International Application No. PCT/CN2023/085193, filed Mar. 30, 2023, the entire disclosure of which is incorporated herein by reference.

### TECHNICAL FIELD

Embodiments of the present disclosure relate to the technical field of communications, and particularly relate to a method for transmitting paging messages, and a core network element and a network device thereof.

### RELATED ART

The 3^{rd} Generation Partnership Project (3GPP) is supporting satellites that utilize a store-and-forward mode. The store-and-forward mode refers to that in a non-terrestrial network (NTN), a service link that a satellite serves a user and a feeder link between the satellite and a ground gateway may not be used simultaneously, and the satellite needs to store transmitted data in a case where one link is connected and forward the transmitted data in a case where the other link is connected.

### SUMMARY

Embodiments of the present disclosure provide a method for transmitting paging messages, and a core network element and a network device thereof. The technical solutions are as follows.

According to some embodiments of the present disclosure, a method for transmitting paging messages is provided. The method is performed by a core network element. The method includes: transmitting a first paging message, wherein the first paging message is configured for a network device to determine a timing for transmitting a second paging message, and the first paging message carries at least one of: position-associated information of a paged terminal or time-associated information.

According to some embodiments of the present disclosure, a core network element is provided. The core network element is configured to: transmit a first paging message, wherein the first paging message is configured for a network device to determine a timing for transmitting a second paging message, and the first paging message carries at least one of: position-associated information of a paged terminal or time-associated information.

According to some embodiments of the present disclosure, a network device is provided. The network device is configured to: receive a first paging message from a core network element, wherein the first paging message is configured to determine a timing for transmitting a second paging message, and the first paging message carries at least one of: position-associated information of a paged terminal or time-associated information.

### BRIEF DESCRIPTION OF DRAWINGS

For clearer illustration of the technical solutions in the embodiments of the present disclosure, the accompanying drawings required to be used in the description of the embodiments are briefly introduced hereinafter. It is apparent that the accompanying drawings in the description hereinafter are only for some embodiments of the present disclosure, and for those of ordinary skill in the art, other accompanying drawings may be acquired according to the accompanying drawings without creative efforts.

FIG. 1 is a diagram of a satellite network architecture for transparent forwarding according to some embodiments of the present disclosure;

FIG. 2 is a diagram of a satellite network architecture for regenerative forwarding according to some embodiments of the present disclosure;

FIG. 3 is a flowchart of a method for transmitting paging messages according to some embodiments of the present disclosure;

FIG. 4 is a flowchart of a method for transmitting paging messages according to some embodiments of the present disclosure;

FIG. 5 is a flowchart of a method for transmitting paging messages according to some embodiments of the present disclosure;

FIG. 6 is a flowchart of a method for transmitting paging messages according to some embodiments of the present disclosure;

FIG. 7 is a schematic diagram of a method for transmitting paging messages according to some embodiments of the present disclosure;

FIG. 8 is a schematic diagram of a method for transmitting paging messages according to some embodiments of the present disclosure;

FIG. 9 is a schematic diagram of an apparatus for transmitting paging messages according to some embodiments of the present disclosure;

FIG. 10 is a schematic diagram of an apparatus for transmitting paging messages according to some embodiments of the present disclosure; and

FIG. 11 is a schematic structural diagram of a communication device according to some embodiments of the present disclosure.

### DETAILED DESCRIPTION

For clearer descriptions of the objectives, technical solutions, and advantages of the present disclosure, the embodiments of the present disclosure are further described in detail hereinafter with reference to the accompanying drawings.

With the increasing demand for speed, latency, high-speed mobility, and energy efficiency, coupled with the increasing diversity and complexity of future services, the 3GPP international standards organization has begun developing 5th Generation (5G) communications. The main application scenarios for 5G includes: enhanced mobile ultra-broadband (eMBB), ultra-reliable and low-latency communication (URLLC), and massive machine-type communication (mMTC).

The eMBB still aims to provide users with multimedia content, services, and data, and demand for the eMBB is growing rapidly. In addition, because the eMBB may be deployed in different scenarios, such as indoors, in urban areas, and in rural areas, capabilities and requirements of eMBBs vary significantly. Therefore, the eMBB may not be generalized and requires detailed analysis based on specific deployment scenarios. Typical applications of the URLLC include industrial automation, power automation, remote medical operations (surgery), and traffic safety. Typical characteristics of the mMTC include high connection density, small data volumes, latency-insensitive services, low module costs, and long lifespans.

The new radio (NR) may also be deployed independently. In 5G networks, a new radio resource control (RRC) state, that is, an RRC_INACTIVE state, is defined to reduce air interface signaling and quickly restore wireless connections and data services. The RRC-INACTIVE state is different from the RRC_IDLE state and the RRC_ACTIVE state.

RRC_IDLE: Mobility involves user equipment (UE)-based cell selection and reselection. Paging is initiated by the UE, and the paging area is configured by the UE. No UE access stratum (AS) context is present in the network device, and no RRC connection is present.

RRC_CONNECTED: An RRC connection is present, and a UE AS context is present between the network device and the terminal. The network device determines the terminal's position at the cell level, and mobility is controlled by the network device. Unicast data may be transmitted between the terminal and the network device.

RRC_INACTIVE: Mobility involves UE-based cell selection and reselection. A connection is present between a core network (CN) and the NR, often referred to as a CN-NR connection. The UE AS context is present in a network device. Paging is triggered by a radio access network (RAN). An RAN-based paging area is managed by the RAN. The network device determines the terminal's position based on the RAN's paging area level.

In some embodiments, in the RRC_INACTIVE state, the terminal autonomously returns to the RRC_IDLE state in the following situations:
upon receiving an initial paging message of the CN;
a timer (e.g., T319) is started in a case where an RRC recovery request is initiated, if the timer expires;
when integrity protection verification of Message 4 (MSG4) fails;
when a cell reselects to another radio access technology (RAT); or
entering a restricted service state, for example, a “camp on any cell state.”

In some embodiments, the characteristics of the RRC_INACTIVE state are as follows:
while the connection between the RAN and CN is maintained;
the terminal and at least one network device save the AS context;
the terminal is reachable to the RAN, and relevant parameters are configured by the RAN;
when the terminal moves within the RAN notification area (RNA) configured by the RAN, the network does not need to be notified, but when the terminal moves outside the RNA, the network device needs to be notified;
when the terminal moves within the RNA, the terminal follows the cell selection reselection method.

Prior to introduction of the technical solutions of this disclosure, concepts related to this disclosure are described.

### Paging Mechanism:

Currently, NR systems support both CN-triggered paging and RAN-triggered paging.

The CN-triggered paging is initiated by an access and mobility management function (AMF) and the AMF pages the terminal within an entire registration area. That is, the AMF transmits paging messages (e.g., an S1AP messages) to network devices within the entire registration area, and then the network devices transmit the paging messages within their respective cells.

In some embodiments, the RAN-triggered paging is initiated by an anchor network device (anchor gNB) of the UE, the gNB pages the terminal within an entire RAN notification area. That is, the anchor gNB transmits RAN paging messages (e.g., an XnAP messages) to the network devices within the RAN notification area, and then the network devices transmit paging messages within their respective cells.

### Background of Non Terrestrial Network (NTN):

3GPP is currently researching NTN technology, which generally uses satellite communications to provide communication services to terrestrial users. Compared to terrestrial cellular communications, satellite communications offer many unique advantages. First, satellite communications are not restricted by user position. For example, conventional terrestrial communications may not cover areas such as oceans, high mountains, and deserts where communication device is unavailable or sparsely populated. However, satellite communications may cover a large area with a single satellite. Furthermore, satellites orbit the Earth, so theoretically, every corner of the Earth may be covered by satellite communications. Second, satellite communications have significant social value. Satellite communications may provide low-cost coverage in remote mountainous areas and impoverished countries and regions, such that people in these areas are enabled to enjoy advanced voice communications and mobile internet technologies, thereby helping narrow the digital divide with developed regions and promoting regional development. Furthermore, satellite communications offer long range, and increasing communication distance does not significantly increase communication costs. Finally, satellite communications are highly stable and unaffected by natural disasters.

Communication satellites are categorized by orbital altitude into low-Earth orbit (LEO), medium-Earth orbit (MEO), geostationary Earth orbit (GEO), and high elliptical orbit (HEO). Currently, research focuses on the LEO and the GEO.
1. LEO: An altitude range of low earth orbit satellites is 500 km to 1500 km, and the corresponding orbital period is about 1.5 hours to 2 hours. A signal propagation delay of single hop communication between users is generally less than 20 ms. A maximum satellite visibility time is 20 minutes. A signal propagation distance is short, link loss is low, and transmission power requirements for user terminals are not stringent.
2. GEO: Geosynchronous orbit satellite, with an orbit altitude of 35786 km and a rotation period of 24 hours around the earth. The signal propagation delay for single hop communication between users is generally 250 ms.

To ensure satellite coverage and increase the system capacity of the entire satellite communication system, satellites use multiple beams to cover the ground. A single satellite may form dozens or even hundreds of beams to cover the ground, and a single satellite beam may cover a ground area with a diameter of tens to hundreds of kilometers.

### Satellite Network Architecture:

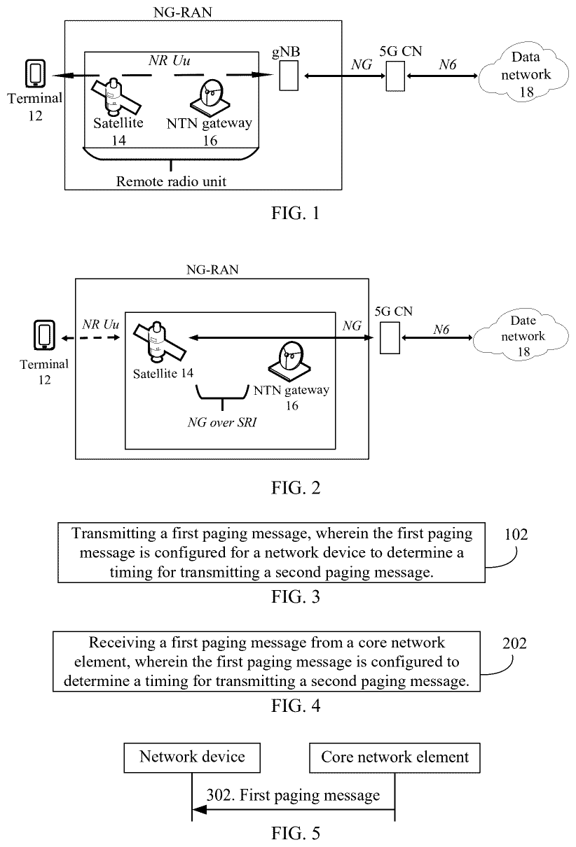

Currently, 3GPP is considering two types of satellites: satellites with transparent payload, as illustrated in FIG. 1, and satellites with regenerative payload, as illustrated in FIG. 2. FIGS. 1 and 2 describe communication between a terminal 12 and a data network 18.

For example, an NTN network consists of the following network elements.
One or more gateways: used to connect the satellite and the terrestrial public network.
Feeder Link: a link used for communication between the gateway and the satellite.
Service Link: a link used for communication between the terminal and the satellite.
Satellite: based on the functions that the satellite provides, the satellites may be categorized into two types: transparent payload and regenerative payload.
Transparent payload: only provides radio frequency filtering, frequency conversion, and amplification. The transparent payload only provides transparent signal forwarding without changing the waveform of the forwarded signal.
Regenerative payload: in addition to providing radio frequency filtering, frequency conversion, and amplification, the regenerative payload may also provide demodulation/decoding, routing/conversion, and coding/modulation. The regenerative payload has some or all of the functions of a base station.
Inter-Satellite Links (ISLs): The ISLs are present in regenerative payload scenarios.

In some embodiments, a feeder link refers to a wireless link between satellite 14 and an NTN gateway 16, which is typically located on the ground.

### Store-and-Forward Mode:

3GPP is currently considering satellites using store-and-forward mode. This mode requires that the service link for the satellite serving users and the feeder link between the satellite and the ground gateway in the NTN network are not available simultaneously. In this case, the satellite is required to store the transmitted data in a case where one link is connected and forward the transmitted date in a case where the other link is connected.

Based on this, the cost of ground gateway deployment will be reduced and deployment flexibility will be improved, which may also be understood as eliminating the need to deploy ground gateways close to users. It should be understood that the store-and-forward mode is suitable for services that are less sensitive to latency requirements.

In current networks, when the core network triggers paging, the core network node transmits paging messages to base stations (e.g., a gNBs and an eNBs) within the area registered by a terminal over a network interface. The paging message carries the UE identifier (UE ID). Upon receiving the paging message, the base station transmits the paging message over the air interface. Therefore, the base station does not need to know the specific areas registered by the terminal and simply passively forwards the paging request of the core network. Furthermore, base station forwarding the paging message of the core network is triggered on a one-to-one basis, that is, the core network triggers a paging request, and the base station forwards the paging request once.

However, in a case where the satellite support store-and-forward mode, the satellite connected to the core network when paging is triggered may be very far from the terminal's position. That is, the area covered by the satellite does not fall within the area registered by the terminal in the core network. In this case, when the satellite directly forwards the paging message as described above, it is likely that the terminal may not be found. Therefore, when the satellite forwards the paging message needs remains to be a challenge to be addressed.

The present disclosure provides a method for transmitting paging messages. By transmitting a first paging message by a core network element to a network device, the network device is capable of determining a timing for transmitting a second paging message. It may be understood that the core network element transmits the first paging message to the satellite, and the satellite determines the timing for transmitting the second paging message (i.e., the forwarded paging message) based on the first paging message, such that the terminal is enabled to receive the paging message forwarded by the satellite, thereby reducing the possibility of paging failure.

FIG. 3 illustrates a flowchart of a method for transmitting paging messages according to some embodiments of the present disclosure. The method is performed by a core network element. The method includes process 102.

In process 102, the core network element transmits a first paging message.

For example, the first paging message is configured for a network device to determine a timing for transmitting a second paging message.

In some embodiments, the second paging message is transmitted by the network device over an air interface. That is, the first paging message is configured for the network device to determine the timing for transmitting the second paging message over the air interface. The network device may be implemented as a base station, a satellite, or the like.

In some embodiments, the first paging message carries at least one of position-associated information of a paged terminal or time-associated information.

The position-associated information of the paged terminal indicates position information associated with the terminal. This information may be either an absolute or relative position, such as global navigation satellite system (GNSS) coordinates of the terminal.

In some embodiments, the position-associated information includes at least one of: registration position information of a terminal; serving cell information associated with a serving cell that last served the terminal; information of a tracking area to which a serving cell that last served the terminal belongs; a satellite position associated with a satellite that last served the terminal; neighbor cell information associated with a neighbor cell of a serving cell that last served the terminal; a radio frequency fingerprint associated with a radio frequency that is present when the terminal was last served; or position information of the terminal.

In some embodiments, the registration position information includes at least one of: a tracking area (TA) list, a tracking area code (TAC) list, or a tracking area identity (TAI) list. In some embodiments, the serving cell information includes at least one of a physical cell identity (PCI) of a serving cell or a frequency point of the serving cell. In some embodiments, the radio frequency fingerprint includes at least one of: a radar fingerprint, a microwave fingerprint, a wireless fidelity (Wi-Fi) fingerprint, or a Bluetooth fingerprint. In some embodiments, the position information of the terminal includes at least one of: GNSS position information, or position information acquired using a positioning method, for example, acquiring the position information of the terminal from a location management function (LMF) by positioning.

In some embodiments, position-associated information is acquired by at least one of: receiving a message reported over a non-access stratum (NAS) by the terminal, or receiving a message reported over a network interface (e.g., an N1/S1 interface) by a network device that has established a connected service with the terminal. For example, prior to or subsequent to releasing the RRC connection of the terminal, the serving base station of the terminal in the connection state reports information to a core network element over the N1/S1 interface. Subsequently, the core network element may determine the position-associated information based on the acquired reported information.

The time-associated information indicates the time associated with the transmission of the second paging message. This information may be absolute time or relative time, for example, the coordinated universal time (UTC) at which the second paging message is transmitted.

In some embodiments, the time-associated information includes at least one of a paging start time or a paging time window. In some embodiments, the paging start time includes at least one of a UTC or a relative time referenced to the time when the first paging message is transmitted or received. In some embodiments, the paging time window includes at least one of the paging start time or a paging end time.

For example, the paging time window includes the paging start time and the paging end time, both of which may be an absolute time or a relative time; or the paging time window includes an absolute time and a duration, such that a duration derived from two times is an absolute duration.

In some embodiments, the time-associated information is determined based on at least one of: position-associated information of the terminal, orbit information of a satellite that is serving the terminal, an orbit speed of the satellite, or a beam coverage of the satellite. For description of the position-associated information of the terminal, reference may be made to the content as described above, which is not elaborated herein.

With reference to the above description, the core network element transmits the first paging message to the network device, such that the network device is capable of determining the timing for transmitting the second paging message based on the first paging message. In some embodiments, the first paging message may be transmitted after the core network element receives mobile terminated data, that is, when mobile terminal data reaches, the core network element transmits the first paging message.

In some embodiments, the core network element is an AMF or a mobility management entity (MME). That is, the first paging message is transmitted by the AMF or the MME. For example, the first paging message may be transmitted over an extended S1AP interface or N1 interface, or the first paging message may be implemented as inter-node UE radio paging message.

In some embodiments, the first paging message is received by a network device that supports store-and-forward mode. For example, the first paging message is received by a satellite that supports store-and-forward mode.

Subsequent to receiving the first paging message, the network device may determine the timing for transmitting the second paging message based on the received message. In some embodiments, the second paging message may at least carry identification information of the paged terminal to facilitate forwarding of the paging message.

It should be understood that the first paging message and the second paging message are both types of paging messages, but they carry different information. The specific information carried may be referred to above not elaborated herein. A paging message may also be referred to as a paging request, paging information, or the like, which is not limited in the present disclosure.

In some embodiments, to increase the probability of successful transmission of the second paging message, the core network element may further transmit the number of transmission times of the second paging message to the network device, such that the network device is instructed to transmit the second paging message once or multiple times, thereby ensuring that the paged terminal may receive the second paging message.

In summary, in the method for transmitting paging messages according to the embodiments of the present disclosure, the core network element transmits the first paging message, such that the network device determines the timing for transmitting the second paging message, thereby implementing forwarding of paging messages in a store-and-forward mode.

FIG. 4 illustrates a flowchart of a method for transmitting paging messages according to some embodiments of the present disclosure. The method is performed by a network device. The method includes process 202.

In process 202, the network device receives a first paging message from a core network element.

For example, the first paging message is configured to determine a timing for transmitting a second paging message.

In some embodiments, the second paging message is transmitted by the network device over the air interface. That is, the first paging message is configured for the network device to determine the timing for transmitting the second paging message over the air interface. The network device may be implemented as a base station, a satellite, or the like.

In some embodiments, the first paging message carries at least one of position-associated information of a paged terminal or time-associated information. The position-associated information indicates position information associated with the terminal, which may be either an absolute position or a relative position. The time-associated information indicates time information associated with the transmission of the second paging message, which may be either absolute time or relative time.

In some embodiments, the position-associated information includes at least one of: registration position information of a terminal; serving cell information associated with a serving cell that last served the terminal; information of a tracking area to which a serving cell that last served the terminal belongs; a satellite position associated with a satellite that last served the terminal; neighbor cell information associated with a neighbor cell of a serving cell that last served the terminal; a radio frequency fingerprint associated with a radio frequency that is present when the terminal was last served; or position information of the terminal.

In some embodiments, position-associated information may be acquired by at least one of: receiving a message reported over NAS by the terminal, or receiving a message reported over the network interface by the network device that has established a connection-state service with the terminal.

For description of the position-associated information, reference may be made to the content as described above, which is not elaborated herein.

In some embodiments, the time-associated information includes at least one of a paging start time or a paging time window. In some embodiments, the time-associated information is determined based on at least one of: position-associated information of the terminal, orbit information of a satellite that is serving the terminal, an orbit speed of the satellite, or a beam coverage of the satellite.

For description of the time-associated information, reference may be made to the content as described above, which is not elaborated herein.

Subsequent to receiving the first paging message from the core network element, the network device may determine the timing for transmitting the second paging message based on the first paging message. In some embodiments, the core network element is an AMF or MME, and the second paging message at least carries identification information of the paged terminal. It should be understood that the first paging message and the second paging message are both types of paging messages, but the information carried the first paging message and the second paging message are different. For the specific information carried, reference may be made to the above content, which is not elaborated herein.

In some embodiments, the first paging message is received by a network device that supports store-and-forward mode. For example, the first paging message is received by a satellite that supports store-and-forward mode. It may be understood that the network device may be implemented as a satellite supporting store-and-forward mode.

In some embodiments, to increase the probability of successfully transmitting the second paging message, the core network element may further transmit the number of transmission times of the second paging message to the network device, such that the network device is instructed to transmit the second paging message once or multiple times, thereby ensuring that the paged terminal may receive the second paging message. In this case, the network device may receive the number of paging times indicated by the core network element, and then transmit the second paging message once or multiple times based on the number of paging times.

In summary, in the method for transmitting paging messages according to the embodiments of the present disclosure, the core network element transmits the first paging message, such that the network device determines the timing for transmitting the second paging message, thereby implementing forwarding of paging messages in a store-and-forward mode.

FIG. 5 illustrates a flowchart of a method for transmitting paging messages according to some embodiments of the present disclosure. The method includes process 302.

In process 302, a core network element transmits a first paging message to a network device.

For example, the first paging message is configured for the network device to determine a timing for transmitting a second paging message.

In some embodiments, the second paging message is transmitted by a network device over the air interface. That is, the first paging message is configured for the network device to determine the timing for transmitting the second paging message over the air interface. The network device may be implemented as a base station, a satellite, or the like. For example, the core network element is implemented as at least one of an AMF or an MME, and the network device is implemented as a satellite supporting store-and-forward mode.

Referring to the above description, the first paging message at least carries at least one of position-associated information of the paged terminal or time-associated information.

The position-associated information may include at least one of: registration position information of a terminal; serving cell information associated with a serving cell that last served the terminal; information of a tracking area to which a serving cell that last served the terminal belongs; a satellite position associated with a satellite that last served the terminal; neighbor cell information associated with a neighbor cell of a serving cell that last served the terminal; a radio frequency fingerprint associated with a radio frequency that is present when the terminal was last served; or position information of the terminal. The time-associated information may include at least one of a paging start time or a paging time window.

For description of the position-associated information and the time-associated information, reference may be made to the content as described above, which is not elaborated herein.

In some embodiments, the network device that receives the first paging message may be far away from the paged terminal. In this case, the network device may store the first paging message and determine the timing for transmitting the second paging message based on the first paging message. For example, the network device is implemented as a satellite supporting the store-and-forward mode. When the satellite flies to the area where the paged terminal is located or at the time indicated by the time-associated information, the satellite transmits the second paging message carrying the terminal identifier of the paged terminal.

In some embodiments, to increase the probability of successfully transmitting the second paging message, the core network element may further transmit the number of transmission times of the second paging message to the network device, such that the network device is instructed to transmit the second paging message once or multiple times, thereby ensuring that the paged terminal may receive the second paging message. Still taking the network device as the satellite supporting the store-and-forward mode as an example, when the satellite flies to the area where the paged terminal is located, or at the time indicated by the time-associated information, the satellite transmits the second paging message carrying the terminal identifier of the paged terminal once or multiple times.

In summary, in the method for transmitting paging messages according to the embodiments of the present disclosure, the core network element transmits the first paging message, such that the network device determines the timing for transmitting the second paging message, thereby implementing forwarding of paging messages in a store-and-forward mode.

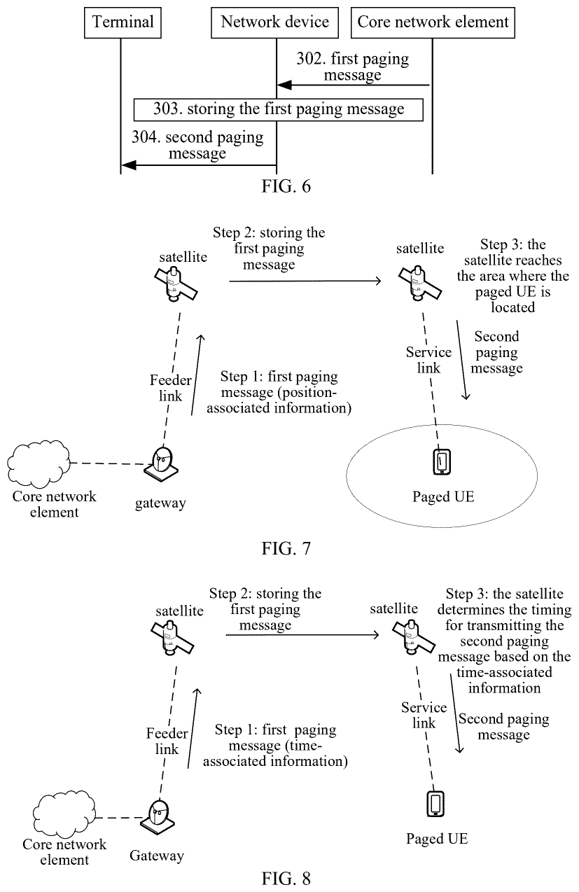

Referring to FIG. 5, FIG. 6 is a flowchart of a method for transmitting paging messages according to some embodiments of the present disclosure. The method further includes processes 303 and 304.

In process 303, the network device stores the first paging message.

In process 304, the network device transmits the second paging message.

For description of the first paging message, reference may be made to the content as described above, which is not elaborated herein.

Taking the network device implemented as the satellite supporting the store-and-forward mode as an example, the core network element transmits the first paging message to the satellite. The first paging message carries at least one of position-associated information or time-associated information of the paged terminal. In a case where the satellite is far from the paged terminal, the satellite stores the first paging message. Subsequently, the satellite determines, based on the first paging message, the timing for transmitting the second paging message, and transmits the second paging message at that timing.

In some embodiments, the core network element may further indicate to the network device the number of transmission times the second paging message should be transmitted. In this case, process 304 may be implemented as follows: the network device transmits the second paging message once or multiple times.

It should be understood that because the timing for transmitting the second paging message is determined based on the first paging message, the timing for transmitting the second paging message is linked to the specific information carried in the first paging message. In some embodiments, the timing for transmitting the second paging message includes a timing at which at least one of the following conditions is satisfied.
Information of a tracking area broadcast by the network device belongs to the registration position information of the terminal.
The serving cell information associated with the network device matches the serving cell information provided by the core network element, and the serving cell information provided by the core network element indicates information associated with a serving cell that last served the terminal.
A distance between a satellite position of the network device and a satellite position provided by the core network element is less than a threshold, wherein the satellite position provided by the core network element indicates information associated with a satellite that last served the terminal.
A coverage area of the network device includes an area indicated by the position information of the terminal.
The network device detects a radio frequency fingerprint, wherein the radio frequency fingerprint indicates information associated with the radio frequency that is present when the terminal was last served.
A paging start time indicated by the first paging message is reached.
A current time falls within the paging time window indicated by the first paging message.

It should be understood that the serving cell information and satellite position provided by the core network element may be understood as part of the position-associated information carried in the first paging message as described above.

In some embodiments, the first paging message carries the position-associated information of the paged terminal, the network device transmits the second paging message in a case where the information of the tracking area broadcast by the network device belongs to the registration position information of the terminal; or the network device transmits the second paging message in a case where the serving cell information associated with the network device matches the serving cell information provided by the core network element; or the network device transmits the second paging message in a case where the distance between the satellite position of the network device and the satellite position provided by the core network element is very small. Other transmission timings determined based on position-associated information include a timing at which at least one of the following conditions is satisfied: the coverage area of the network device includes the area indicated by the position information of the terminal, or the network device detects a radio frequency fingerprint. For description of the registration position information, serving cell information, satellite position, position information of the terminal, and radio frequency fingerprint, reference may be made to the content as described above, which is not elaborated herein.

In some other embodiments, the first paging message carries time-associated information, and the network device begins the transmission of the second paging message in the case where the paging start time is reached; alternatively, the network device transmits the second paging message within the paging time window. For description of the paging start time and the paging time window, reference may be made to the content as described above, which is not elaborated herein.

Referring to the above, the timing at which the network device transmits the second paging message varies depending on the content carried in the first paging message. Taking the core network element implemented as an AMF/MME and the network device implemented as a base station (e.g., a satellite) supporting store-and-forward mode as an example, two specific implementations are described hereinafter.

### 1. The First Paging Message Carries Position-Associated Information of the Paged UE.

FIG. 7 illustrates a schematic diagram of a method for transmitting paging messages according to some embodiments of the present disclosure. In these embodiments, the method for transmitting paging messages includes the following steps.

Step 1: The core network transmits the first paging message to the satellite over a gateway.

The first paging message carries position-associated information of a paged UE, wherein the position-associated information may also be referred to as UE position-associated information.

In some embodiments, upon arrival of MT data, the AMF/MME transmits the first paging message to the base station. In some embodiments, the first paging message may be implemented as a paging message of an extended S1AP interface or N1 interface, or as inter-node UE radio paging message.

In some embodiments, the UE position-associated information may be one or more of the following:
a) registration position information of the UE in the core network, such as a TA list, a TAC list, or a TAI list;
b) information of a serving cell that last served the UE, such as at least one of the PCI or the frequency point of the serving cell;
c) information of the TA to which the serving cell that last served the UE belongs;
d) a position of a satellite that last served the UE, such as the position of the satellite acquired by the UE from the ephemeris broadcast by the serving cell in the connected state;
e) neighbor cell information or a radio frequency fingerprint of the UE when the UE was last served, wherein the radio frequency fingerprint includes but is not limited to a radar fingerprint, a microwave fingerprint, a Wi-Fi fingerprint, or a Bluetooth fingerprint; or
f) position information of the UE, such as the GNSS position information of the UE, or position information acquired from the LMF using a positioning method.

In some embodiments, the information mentioned in b, c, d, e, and f may be notified to the core network in at least one of the following manners.
i. The UE reports to the AMF/MME over a NAS message.
ii. A connected serving base station of the UE reports to the AMF/MME over a network interface (e.g., N1/S1), e.g., prior to or subsequent to releasing the RRC connection of the UE.

Step 2: The satellite stores the first paging message.

Step 3: When the satellite reaches the area where the paged UE is located, the satellite transmits the second paging message.

Referring to the content as described above, subsequent to receiving the first paging message from the core network, the base station determines the timing for transmitting the second paging message over the air interface based on the UE position related information in the first paging message.

In some embodiments, step 3 may be implemented as one of the following steps.
a) When the information of the TA currently broadcast by the base station belongs to the registration position information of the UE in the core network, the base station transmits the second paging message.
b) When the current serving cell information of the base station matches the previous serving cell information of the UE provided by the core network, the base station transmits the second paging message.
c) When the satellite position is very close to the previous serving satellite position of the UE provided by the core network, the base station transmits the second paging message. Whether the position is very close may be determined by a threshold. The threshold value may be set based on actual needs and is not limited in the present disclosure.
d) When the cell coverage area of the satellite includes the position information of the UE provided by the core network, the base station transmits the second paging message.
e) When the satellite detects the radio frequency fingerprint provided by the core network, the base station transmits the second paging message.

Furthermore, when transmitting the first paging message to the base station, the core network may instruct the base station on the number of transmission times for transmitting the second paging message over the air interface, and the base station then transmits the second paging message one or more times based on the instruction.

### 2. The First Paging Message Carries Time-Associated Information.

FIG. 8 illustrates a schematic diagram of a method for transmitting paging messages according to some embodiments of the present disclosure. In these embodiments, the method for transmitting paging messages includes the following steps.

Step 1: The core network transmits the first paging message to the satellite over a gateway.

The first paging message carries time-associated information, wherein the time-associated information may also be referred to as time-related information. Similar to the embodiments as described above, upon arrival of MT data, the AMF/MME transmits the first paging message to the base station. The first paging message may be implemented as a paging message of an extended S1AP interface or N1 interface, or as inter-node UE radio paging information message.

In some embodiments, the time-associated information may be one or more of the following:
a) a paging start time, wherein the paging start time may be an absolute time (e.g., UTC) or a relative time referenced to the time when the base station receives the first paging message; or
b) a paging time window, wherein the paging time window includes a start time and an end time, wherein the start time and the end time are in the form of two absolute times or relative times; or the start time and the end time include an absolute time and a duration.

In some embodiments, the core network may determine the above time based on the position-associated information of the UE and information such as the orbit speed/beam coverage of the satellite.

Step 2: The satellite stores the first paging message.

Step 3: The satellite determines the timing for transmitting the second paging message based on the time-associated information and transmits the second paging message to a paged UE.

Referring to the foregoing contents, subsequent to receiving the first paging message from the core network, the base station determines the timing for transmitting the second paging message over the air interface based on the time-associated information in the first paging message.

In some embodiments, step 3 may be implemented as one of the following.
a) The base station begins the transmission of the second paging message after the start time is reached.
b) The base station transmits the second paging message within the paging time window provided by the core network.

Similar to the above example, in addition, when transmitting the first paging message to the base station, the core network may instruct the base station on the number of transmission times that the second paging message is to be transmitted over the air interface, and the base station then transmits the second paging message once or multiple times based on the instruction.

In summary, in the method for transmitting paging messages according to some embodiments of the present disclosure, the core network element transmits the first paging message, such that the network device determines the timing for transmitting the second paging message, thereby implementing forwarding of paging messages in a store-and-forward mode.

In some embodiments, two optional implementations are provided based on the information carried by the first paging message, and the network device is enabled to specifically determine the timing for transmitting the second paging message based on the information carried by the first paging message.

The following are apparatus embodiments of the present disclosure. For details not described in detail in the apparatus embodiments, reference may be made to the corresponding descriptions in the above-mentioned method embodiments and are not elaborated herein.

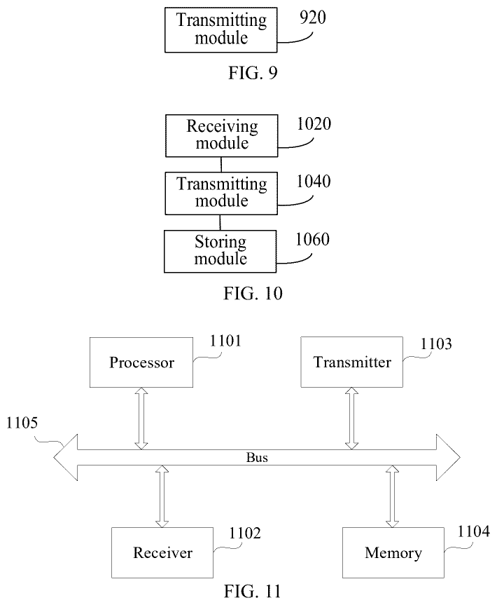

FIG. 9 illustrates a schematic diagram of an apparatus for transmitting paging messages according to some embodiments of the present disclosure. The apparatus includes a transmitting module 920.

The transmitting module 920 is configured to transmit a first paging message, wherein the first paging message is configured for a network device to determine a timing for transmitting a second paging message.

In some embodiments, the first paging message carries at least one of position-associated information of a paged terminal or time-associated information.

In some embodiments, the position-associated information includes at least one of: registration position information of a terminal, serving cell information associated with a serving cell that last served the terminal, information of a tracking area to which a serving cell that last served the terminal belongs, a satellite position associated with a satellite that last served the terminal, neighbor cell information associated with a neighbor cell of a serving cell that last served the terminal, a radio frequency fingerprint associated with a radio frequency that is present when the terminal was last served, or position information of the terminal.

In some embodiments, the registration position information includes at least one of a TA list, a TAC list, or a TAI list.

In some embodiments, the serving cell information includes at least one of a PCI of the serving cell or a frequency point of the serving cell.

In some embodiments, the radio frequency fingerprint includes at least one of: a radar fingerprint, a microwave fingerprint, a Wi-Fi fingerprint, or a Bluetooth fingerprint.

In some embodiments, the position-associated information is acquired by at least one of: receiving a message reported over a NAS by the terminal, or receiving a message reported over a network interface by a network device that has established a connection-state service with the terminal.

In some embodiments, the time-associated information includes at least one of a paging start time or a paging time window.

In some embodiments, the paging start time includes at least one of a UTC or a relative time relative to a time at which the first paging message is transmitted or received.

In some embodiments, the paging time window includes at least one of the paging start time or a paging end time.

In some embodiments, the time-associated information is determined based on at least one of: position-associated information of the terminal, orbit information of a satellite that is serving the terminal, an orbit speed of the satellite, or a beam coverage of the satellite.

In some embodiments, the transmitting module 920 is further configured to transmit number of transmission times of the second paging message.

In some embodiments, the core network element is an AMF or a MME.

In some embodiments, the first paging message is received by a network device supporting store-and-forward mode.

In some embodiments, the second paging message at least carries identification information of a paged terminal.

FIG. 10 illustrates a schematic diagram of an apparatus for transmitting paging messages according to some embodiments of the present disclosure. The apparatus includes a receiving module 1020.

The receiving module 1020 is configured to receive a first paging message from a core network element, wherein the first paging message is configured to determine a timing for transmitting a second paging message.

In some embodiments, the first paging message carries at least one of position-associated information of a paged terminal or time-associated information.

In some embodiments, the position-associated information includes at least one of: registration position information of a terminal, serving cell information associated with a serving cell that last served the terminal, information of a tracking area to which a serving cell that last served the terminal belongs, a satellite position associated with a satellite that was last served the terminal, neighbor cell information associated with a neighbor cell of a serving cell that last served the terminal, a radio frequency fingerprint associated with a radio frequency that is present when the terminal was last served, or position information of the terminal.

In some embodiments, the time-associated information includes at least one of a paging start time or a paging time window.

In some embodiments, the apparatus further includes: a transmitting module 1040, configured to transmit the second paging message.

In some embodiments, the timing for transmitting the second paging message includes a timing at which at least one of the following conditions is satisfied: information of a tracking area broadcast by the network device belongs to registration position information of a terminal; serving cell information associated with the network device matches serving cell information provided by the core network element, wherein the serving cell information provided by the core network element indicates information associated with a serving cell that last served the terminal; a distance between a satellite position of the network device and a satellite position provided by the core network element is less than a threshold, wherein the satellite position provided by the core network element indicates information associated with a satellite that last served the terminal; a coverage area of the network device includes an area indicated by position information of the terminal; the network device detects a radio frequency fingerprint, wherein the radio frequency fingerprint indicates information associated with a radio frequency that is present when the terminal was last served; a paging start time indicated by the first paging message is reached; or a current time falls within a paging time window indicated by the first paging message.

In some embodiments, the transmitting module 1040 is configured to transmit the second paging message once or multiple times.

In some embodiments, the apparatus further includes: a storing module 1060, configured to store the first paging message.

In some embodiments, the second paging message at least carries identification information of a paged terminal.

FIG. 11 illustrates a schematic structural diagram of a communication device (terminal or network device) according to some embodiments of the present disclosure. The communication device includes: a processor 1101, a receiver 1102, a transmitter 1103, a memory 1104, and a bus 1105.

The processor 1101 includes one or more processing cores, and the processor 1101 executes various functional applications and performs information processing by running software programs and modules.

The receiver 1102 and the transmitter 1103 may be implemented as one communication assembly, wherein the communication assembly may be one communication chip.

The memory 1104 is communicably connected to the processor 1101 over the bus 1105.

The memory 1104 is configured to store at least one instruction, and the processor 1101 is configured to execute the at least one instruction to perform the processes in the method for transmitting paging messages as described in the embodiments of the present disclosure.

In addition, the memory 1104 may be implemented by any type or combination of volatile or non-volatile storage devices including, but not limited to: a magnetic or optical disk, an electrically-erasable programmable read-only memory (EEPROM), an erasable programmable read-only memory (EPROM), a static random access memories (SRAM), a read-only memory (ROM), a magnetic memory, a flash memory, and a programmable read-only memory (PROM).

In some embodiments, a core network element is provided. The core network element is configured to perform the method for transmitting paging messages as described above.

In some embodiments, a network device is provided. The network device is configured to perform the method for transmitting paging messages as described above.

In some embodiments, a computer-readable storage medium is further provided. The computer-readable storage medium stores one or more computer programs. The one or more computer programs, when loaded and run by a processor, cause the processor to perform the method for transmitting paging messages as describe above.

In some embodiments, a chip is provided. The chip includes programmable logic circuitry and/or one or more program instructions, wherein an electronic device equipped with the chip, when running, is caused to perform the method for transmitting paging messages as described above.

In some embodiments, a computer program product is provided. The computer program product includes one or more computer instructions stored in a computer-readable storage medium. The one or more computer instructions, when read from the computer-readable storage medium and executed by a processor, cause the processor to perform the method for transmitting paging messages as described above.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Combinations such as “at least one of A, B, or C,” “at least one of A, B, and C,” and “A, B, C, or any combination thereof” include any combination of A, B, and/or C, and may include multiples of A, multiples of B, or multiples of C. Specifically, combinations such as “at least one of A, B, or C,” “at least one of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

Described above are merely optional embodiments of the present disclosure and are not intended to limit the present disclosure. Any modifications, equivalent substitutions, improvements, and the like, made within the spirit and principle of the present disclosure should fall within the protection scope of the present disclosure.

1. A method for transmitting paging messages, performed by a core network element, the method comprising:
transmitting a first paging message;
wherein the first paging message is configured for a network device to determine a timing for transmitting a second paging message, and the first paging message carries at least one of: position-associated information of a paged terminal or time-associated information.

2. The method according to claim 1, wherein the position-associated information comprises at least one of:
registration position information of a terminal;
serving cell information associated with a serving cell that last served the terminal;
information of a tracking area to which a serving cell that last served the terminal belongs;
a satellite position associated with a satellite that last served the terminal;
neighbor cell information associated with a neighbor cell of a serving cell that last served the terminal;
a radio frequency fingerprint associated with a radio frequency that is present when the terminal was last served; or
position information of the terminal.

3. The method according to claim 2, wherein the registration position information comprises at least one of: a tracking area (TA) list, a tracking area code (TAC) list or a tracking area identity (TAI) list; and/or
the serving cell information comprises at least one of: a physical cell identity (PCI) of the serving cell or a frequency point of the serving cell; and/or
the radio frequency fingerprint comprises at least one of: a radar fingerprint, a microwave fingerprint, a wireless fidelity (Wi-Fi) fingerprint or a Bluetooth fingerprint.

4. The method according to claim 2, wherein the position-associated information is acquired by at least one of the following manners:
receiving a message reported over a non-access stratum (NAS) by the terminal; or
receiving a message reported over a network interface by a network device that has established a connection-state service with the terminal.

5. The method according to claim 1, wherein the time-associated information comprises at least one of: a paging start time or a paging time window.

6. The method according to claim 5, wherein the paging start time comprises at least one of: a coordinated universal time (UTC) or a relative time relative to time at which the first paging message is transmitted or received; and/or
the paging time window comprises at least one of: the paging start time or a paging end time.

7. The method according to claim 5, wherein the time-associated information is determined based on at least one of:
position-associated information of the terminal;
orbit information of a satellite that is serving the terminal;
an orbit speed of the satellite; or
a beam coverage of the satellite.

8. The method according to claim 1, further comprising:
transmitting a number of transmission times of the second paging message.

9. A network device, wherein the network device is configured to:
receive a first paging message from a core network element;
wherein the first paging message is configured to determine a timing for transmitting a second paging message, and the first paging message carries at least one of: position-associated information of a paged terminal or time-associated information.

10. The network device according to claim 9, wherein the network device is further configured to:
transmit the second paging message.

11. The network device according to claim 10, wherein the timing for transmitting the second paging message comprises a timing at which at least one of the following conditions is satisfied:
information of a tracking area broadcast by the network device belongs to registration position information of a terminal;
serving cell information associated with the network device matches serving cell information provided by the core network element, wherein the serving cell information provided by the core network element indicates information associated with a serving cell that last served the terminal;
a distance between a satellite position of the network device and a satellite position provided by the core network element is less than a threshold, wherein the satellite position provided by the core network element indicates information associated with a satellite that last served the terminal;
a coverage area of the network device comprises an area indicated by position information of the terminal;
the network device detects a radio frequency fingerprint, wherein the radio frequency fingerprint indicates information associated with a radio frequency is present when the terminal was last served;
a paging start time indicated by the first paging message is reached; or
a current time falls within a paging time window indicated by the first paging message.

12. The network device according to claim 10, wherein the network device is configured to transmit the second paging message once or multiple times.

13. A core network element, wherein the core network element is configured to:
transmit a first paging message;
wherein the first paging message is configured for a network device to determine a timing for transmitting a second paging message, and the first paging message carries at least one of: position-associated information of a paged terminal or time-associated information.

14. The core network element according to claim 13, wherein the position-associated information comprises at least one of:
registration position information of a terminal;
serving cell information associated with a serving cell that last served the terminal;
information of a tracking area to which a serving cell that last served the terminal belongs;
a satellite position associated with a satellite that last served the terminal;
neighbor cell information associated with a neighbor cell of a serving cell that last served the terminal;
a radio frequency fingerprint associated with a radio frequency that is present when the terminal was last served; or
position information of the terminal.

15. The core network element according to claim 14, wherein the registration position information comprises at least one of: a tracking area (TA) list, a tracking area code (TAC) list or a tracking area identity (TAI) list; and/or
the serving cell information comprises at least one of: a physical cell identity (PCI) of the serving cell or a frequency point of the serving cell; and/or
the radio frequency fingerprint comprises at least one of: a radar fingerprint, a microwave fingerprint, a wireless fidelity (Wi-Fi) fingerprint or a Bluetooth fingerprint.

16. The core network element according to claim 14, wherein the position-associated information is acquired by at least one of the following manners:
receiving a message reported over a non-access stratum (NAS) by the terminal; or
receiving a message reported over a network interface by a network device that has established a connection-state service with the terminal.

17. The core network element according to claim 13, wherein the time-associated information comprises at least one of: a paging start time or a paging time window.

18. The core network element according to claim 17, wherein the paging start time comprises at least one of: a coordinated universal time (UTC) or a relative time relative to time at which the first paging message is transmitted or received; and/or
the paging time window comprises at least one of: the paging start time or a paging end time.

19. The core network element according to claim 17, wherein the time-associated information is determined based on at least one of:
position-associated information of the terminal;
orbit information of a satellite that is serving the terminal;
an orbit speed of the satellite; or
a beam coverage of the satellite.

20. The core network element according to claim 13, wherein the core network element is further configured to:
transmit a number of transmission times of the second paging message.
